(19) United States
(12) Patent Application Publication
(10) Pub. No.: US 2004/0268253 A1
(43) Pub. Date: Dec. 30, 2004

(54) Method and apparatus for installing and using reference materials in conjunction with reading electronic content

(75) Inventors: Marco A. DeMello, Redmond, WA (US); Vikram Madan, Bellevue, WA (US)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(73) Assignee: Microsoft Corporation, Redmond, WA (US)

(21) Appl. No.: 10/891,050

(22) Filed: Jul. 15, 2004

Related U.S. Application Data
(62) Division of application No. 09/455,754, filed on Dec. 7, 1999.

(51) Int. Cl. G06F 17/00

(52) U.S. Cl. 715/526

(57) ABSTRACT

A system and method for installing and using reference materials in conjunction with reading is disclosed. A user selects an object and indicates that he wants further information on the selected object. A reference window is displayed with the requested information. The user may then continue to navigate the displayed reference window to continue to find more information then quickly return to reading the document containing the original object. The users selections are handled by a reference manager that retrieves selected information based on the user's look-up requests. Through the use of header information (which may include meta data), each reference document or book provides information about itself to the reference manager.

### CROSS REFERENCE TO RELATED APPLICATIONS

This application is a divisional of U.S. application Ser. No. 09/455,754 filed Dec. 7, 1999; the contents of said application are hereby incorporated by reference.

### RELATED APPLICATIONS

This application is related to the following applications:

U.S. Ser. No. 09/456,127 (BW 03797.80027), filed Dec. 7, 1999, entitled “Bookmarking and Placemarking a Displayed Document in a Computer System;”

U.S. Ser. No. 09/455,805 (BW 03797.78802), filed Dec. 7, 1999, entitled “System and Method for Annotating an Electronic Document Independently of Its Content;”

U.S. Ser. No. 09/455,806 (BW 03797.84617), filed Dec. 7, 1999, entitled “Method and Apparatus For Capturing and Rendering Annotations For Non-Modifiable Electronic Content;”

U.S. Ser. No. 09/455,808 (BW 03797.84809), filed Dec. 7, 1999, entitled “System, Method and User Interface for Active Reading of Electronic Content;” and,

U.S. Ser. No. 09/455,807 (BW 03797.84618), filed Dec. 7, 1999, entitled “Method and Apparatus for Capturing and Rendering Text Annotations For Non-Modifiable Electronic Content.”

Each of these applications is incorporated by reference in its entirety.

### BACKGROUND

1. Technical Field

The disclosure generally relates to the electronic display of documents. More particularly, the disclosure relates to the inclusion and use of reference documents in conjunction with viewing electronically displayed documents.

2. Related Art

Many factors today drive the development of computers and computer software. One of these factors is the desire to provide accessibility to information virtually anytime and anywhere. The proliferation of notebook computers, personal digital assistants (PDAs), and other personal electronic devices reflect the fact that users want to be able to access information wherever they may be, whenever they want. In order to facilitate greater levels of information accessibility, the presentation of information must be made as familiar and comfortable as possible.

In this vein, one way to foster success of electronic presentations of information will be to allow users to handle information in a familiar manner. Stated another way, the use and manipulation of electronically-presented information may mimic those paradigms that users are most familiar with, e.g., printed documents, as an initial invitation to their use. As a result, greater familiarity between users and their “machines” will be engendered, thereby fostering greater accessibility, even if the machines have greater capabilities and provide more content to the user beyond the user's expectations. Once users feel comfortable with new electronic presentations, they will be more likely to take advantage of an entire spectrum of available functionality.

One manner of encouraging familiarity is to present information in an electronic book format that simulates the look and feel of information presented in paper books. For example, when one is reading a paper book and does not understand a term, one may turn to a paper dictionary or other reference material for help. Once the term has been looked up and reader satisfied with the definition, the reader can quickly return to reading the original book. In the electronic display of documents, however, the ability to immediately look up a word then return to a previous reading location is cumbersome if not difficult. With electronic documents, the navigation to a reference book requires insertion of a reference CD or running of a different program that will look-up information for the user. These actions detract from a goal of pure reading enjoyment. There is no immediate gratification of the desire to look up information quickly followed by the satisfaction of reading the requested information. Simply put, the use of reference materials or programs is not seamless.

### SUMMARY

The present invention provides a technique for allowing a user, while viewing an electronic document or reader, to look up a selected object in at least one reference document or book. After selection of an object and a “look up” option from a list of options, the system retrieves reference information relating to the selected object and displays the retrieved reference information in a reference window (also referred to herein as a “look-up window”). After viewing the displayed reference information, the user may quickly return to reading the original document by tapping on a portion of the screen outside of the reference window.

In the context of the present invention, a “document” or “book” or “title” encompasses all forms of electronically displayable information including but not limited to books, manuals, reference materials, picture books, etc. “Reference books” are intended to encompass all materials that provide additional information on a topic. Reference books include, but are not limited to, dictionaries, thesauruses, foreign language dictionaries, travel guides, encyclopedias, catalogs, textbooks, handbooks, anthologies, and other texts that provide information regarding a topic. Reference books may also include graphical materials including maps, atlases, charts, photo galleries, and other materials that provide information for use by a user. Reference books may also include dynamically updated information, which may or may not be stored along with the reference title or reference book itself. Examples include price lists of all kinds, chemical compositions of specific medical compounds, as well as any timely information that requires real-time database lookups, or a connection to an external information source or sources. In these circumstances, the reference book (or reference title) will identify to the reading application that either the information itself or further details on the result-set provided is available on a remote computer (or external file on a local storage device attached to the computer or device hosting the reading application) and the interface methods required to get at the desired information.

“Object” as used herein encompasses all displayed information. With reference to looking up information regarding the object, the object may be a word or a group of words. Also, the object may be an equation or iconic symbol. Non-displayed information may be associated with the object through various means including, but not limited to, metadata stored in the header of the book or document currently being read and metadata stored in connection with the object itself (for example, a textual description or listing or terms related to a displayed image).

As described herein, the present invention includes an enhanced user interface that provides immediate gratification of being able to quickly look up information for selected objects without having to navigate a complex interface. Also, the user interface provides for navigation between related reference books. In one embodiment, annotation functionality may be combined with the reference look-up functionality. For example, while reading James Michener's Hawaii, a user may select the displayed object “Oahu” and select “look up” from a list of menu options. Next, a display window would be displayed that provides information relating to the object “Oahu” (in this example, as Oahu being an “island” with an “airport”). The user may then select the object “island” for a display of information defining the term “island.” Alternatively, the user may annotate the object “island” (for example, including a bookmark for easy return). Further, the user may select the object “airport” to navigate to a different reference book than that used above (to retrieve information on “Oahu” and “island”) to retrieve flight schedules to and from the airport on Oahu.

The present application also relates to the mechanism underlying the functionality of the display and operation of the reference window or windows. The present invention includes a reference manager that monitors and controls how reference information relating to selected objects is gathered and displayed in the reference window.

For the purpose of this disclosure, annotations are generally related to textual annotations. However, other annotations that may be used include highlighting, drawings (as one would expect to do with a pencil or pen to a paper book), and bookmarks. While the annotations are to be displayed in conjunction with the document, the underlying document is not modified. Related annotations and techniques for creating them are described in the following disclosures:

U.S. Ser. No. 09/456,127 (BW 03797.80027), filed Dec. 7, 1999, entitled “Bookmarking and Placemarking a Displayed Document in a Computer System;”

U.S. Ser. No. 09/455,808 (BW 03797.84809), filed Dec. 7, 1999, entitled “System, Method and User Interface for Active Reading of Electronic Content;”

U.S. Ser. No. 09/455,805 (BW 03797.78802), filed Dec. 7, 1999, entitled “System and Method for Annotating an Electronic Document Independently of Its Content;”

U.S. Ser. No. 09/455,807 (BW 03797.84618), filed Dec. 7, 1999, entitled “Method and Apparatus for Capturing and Rendering Text Annotations For Non-Modifiable Electronic Content,”and

U.S. Ser. No. 09/455,806 (BW 03797.84617), filed Dec. 7, 1999, entitled “Method and Apparatus For Capturing and Rendering Annotations For Non-Modifiable Electronic Content.” which are incorporated herein by reference in their entireties for any enabling disclosure.

To associate an annotation with a selected object, the annotations are linked to a file position in the non-modifiable document. The invention calculates the file position of, for example, the first character of the word (or other displayed element) and stores the file position with the annotation in a separate, linked local file. Alternatively, the non-modifiable document may represent a non-modifiable portion of a file, with the annotations being added to a write-enabled portion of the file.

These and other novel advantages, details, embodiments, features and objects of the present invention will be apparent to those skilled in the art from following the detailed description of the invention, the attached claims and accompanying drawings, listed herein, which are useful in explaining the invention.

### BRIEF DESCRIPTION OF DRAWINGS

FIG. 1 shows a general purpose computer supporting the display and annotation of an electronic document in accordance with embodiments of the present invention.

FIG. 2 shows a displayed document on a computer screen in accordance with embodiments of the present invention.

FIG. 3 shows a displayed document with an object selected in accordance with embodiments of the present invention.

FIG. 4 shows a displayed document with a first reference window in accordance with embodiments of the present invention.

FIG. 5 shows a displayed document with a second reference window in accordance with embodiments of the present invention.

FIG. 6 shows an example of functional relationships relating to the navigability of reference windows in accordance with embodiments of the present invention.

FIGS. 7A and 7B show two file formats for annotations in accordance with embodiments of the present invention.

FIG. 8 shows an example of a user changing the displayed book while navigating reference windows in accordance with embodiments of the present invention.

FIG. 9 shows a storage arrangement for books in accordance with embodiments of the present invention.

FIGS. 10A and 10B show file formats for books with varying metadata information in accordance with embodiments of the present invention.

FIG. 11 shows the conversion process from various documents into a book for use with the present invention.

FIG. 12 shows the relationship of the reference manager to the operating system in accordance with embodiments of the present invention.

FIGS. 13A and 13B shows various embodiments for selecting and displaying content in a reference window in accordance with the present invention.

FIG. 14 shows embodiments for processing new books in accordance with embodiments of the present invention.

### DETAILED DESCRIPTION

The present invention relates to a system and method for installing and using reference materials in an electronic device. The detailed description of the invention is arranged with the following subtitles:

A. Overview of a General Computing Device

B. Description and Use of Reference Windows and Associated Content

C. Description of Book Storage Structure

D. Description of Reference Manager

E. Use of Reference Manager

F. Summary

Although not required, the invention will be described in the general context of computer-executable instructions, such as program modules. Generally, program modules include routines, programs, objects, scripts, components, data structures, etc. that perform particular tasks or implement particular abstract data types. Moreover, those skilled in the art will appreciate that the invention may be practiced with any number of computer system configurations including, but not limited to, distributed computing environments where tasks are performed by remote processing devices that are linked through a communications network. In a distributed computing environment, program modules may be located in both local and remote memory storage devices. The present invention may also be practiced in personal computers (PCs), hand-held devices, multiprocessor systems, microprocessor-based or programmable consumer electronics, network PCs, minicomputers, mainframe computers, and the like.

A. Overview of a General Computing Device

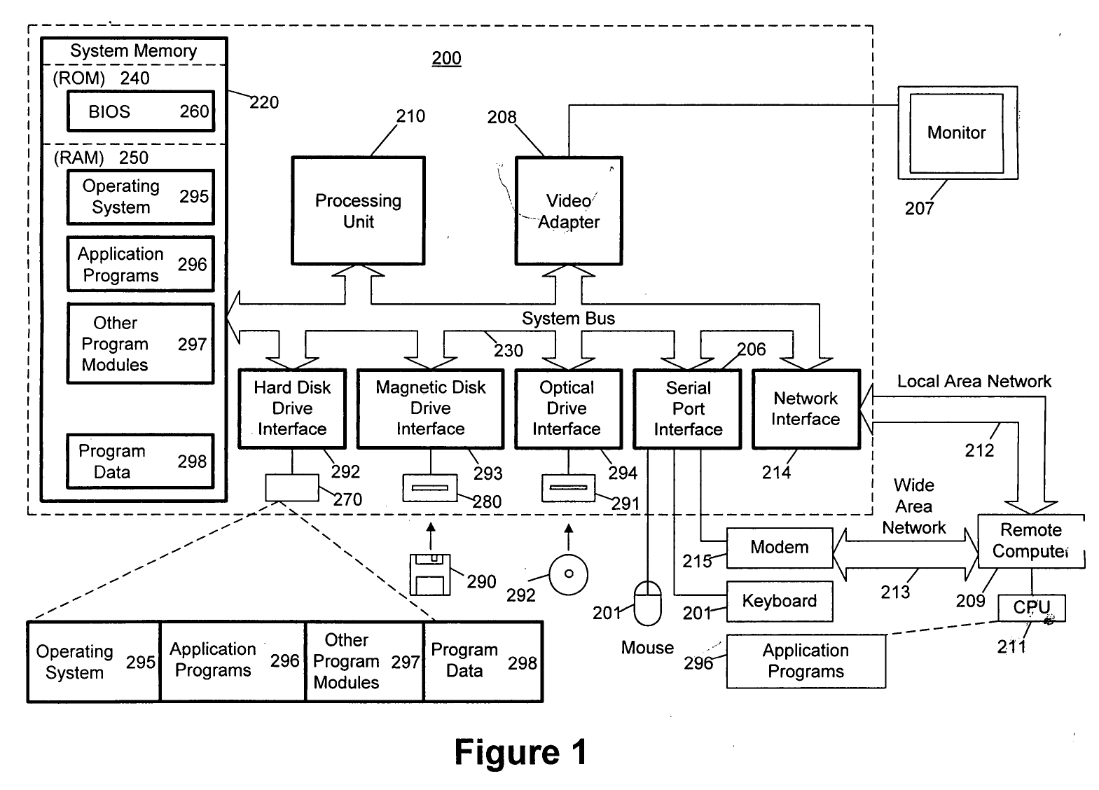

FIG. 1 is a schematic diagram of a computing environment in which the present invention may be implemented. The present invention may be implemented within a general purpose computing device in the form of a conventional personal computer 200, including a processing unit 210, a system memory 220, and a system bus 230 that couples various system components including the system memory to the processing unit 210. The system bus 230 may be any of several types of bus structures including a memory bus or memory controller, a peripheral bus, and a local bus using any of a variety of bus architectures. The system memory includes read only memory (ROM) 240 and random access memory (RAM) 250.

A basic input/output system 260 (BIOS), containing the basic routines that help to transfer information between elements within the personal computer 200, such as during start-up, is stored in ROM 240. The personal computer 200 further includes a hard disk drive 270 for reading from and writing to a hard disk, not shown, a magnetic disk drive 280 for reading from or writing to a removable magnetic disk 290, and an optical disk drive 291 for reading from or writing to a removable optical disk 292 such as a CD ROM or other optical media. The hard disk drive 270, magnetic disk drive 280, and optical disk drive 291 are connected to the system bus 230 by a hard disk drive interface 292, a magnetic disk drive interface 293, and an optical disk drive interface 294, respectively. The drives and their associated computer-readable media provide nonvolatile storage of computer readable instructions, data structures, program modules and other data for the personal computer 200.

Although the exemplary environment described herein employs a hard disk, a removable magnetic disk 290 and a removable optical disk 292, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs), and the like, may also be used in the exemplary operating environment.

A number of program modules may be stored on the hard disk, magnetic disk 290, optical disk 292, ROM 240 or RAM 250, including an operating system 295, one or more application programs 296, other program modules 297, and program data 298. A user may enter commands and information into the personal computer 200 through input devices such as a keyboard 201 and pointing device 202. Other input devices (not shown) may include a microphone, joystick, game pad, satellite dish, scanner, or the like. These and other input devices are often connected to the processing unit 210 through a serial port interface 206 that is coupled to the system bus, but may be connected by other interfaces, such as a parallel port, game port or a universal serial bus (USB). A monitor 207 or other type of display device is also connected to the system bus 230 via an interface, such as a video adapter 208. In addition to the monitor, personal computers typically include other peripheral output devices (not shown), such as speakers and printers.

The personal computer 200 may operate in a networked environment using logical connections to one or more remote computers, such as a remote computer 209. The remote computer 209 may be another personal computer, a server, a router, a network PC, a peer device or other common network node, and typically includes many or all of the elements described above relative to the personal computer 200, although only a memory storage device 211 has been illustrated in FIG. 1. The logical connections depicted in FIG. 1 include a local area network (LAN) 212 and a wide area network (WAN) 213. Such networking environments are commonplace in offices, enterprise-wide computer networks, intranets and the Internet.

When used in a LAN networking environment, the personal computer 200 is connected to the local network 212 through a network interface or adapter 214. When used in a WAN networking environment, the personal computer 200 typically includes a modem 215 or other means for establishing a communications over the wide area network 213, such as the Internet. The modem 215, which may be internal or external, is connected to the system bus 230 via the serial port interface 206. In a networked environment, program modules depicted relative to the personal computer 200, or portions thereof, may be stored in the remote memory storage device. It will be appreciated that the network connections shown are exemplary and other means of establishing a communications link between the computers may be used.

In addition to the system described in relation to FIG. 1, the invention may be practiced on a handheld computer. Further, purpose-built devices may support the invention as well. In short, handheld computers and purpose-built devices are similar in structure to the system of FIG. 1 but may be limited to a display (which may be touch-sensitive to a human finger or stylus), memory (including RAM and ROM), and a synchronization/modem port for connecting the handheld computer and purpose-built devices to another computer or a network (including the Internet) to download and/or upload documents or download and/or upload annotations. The description of handheld computers and purpose-built devices is known in the art and is omitted for simplicity. The invention may be practiced using C. Also, it is appreciated that other languages may be used including C++, assembly language, and the like.

B. Description and Use of Reference Windows and Associated Content

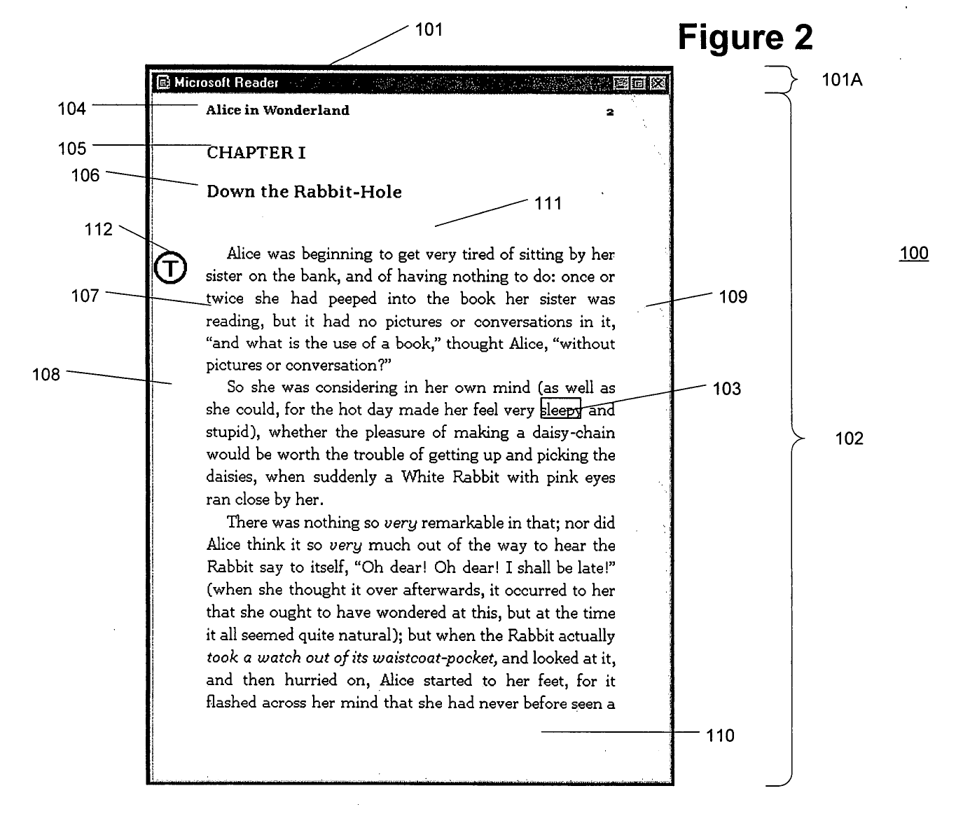

FIG. 2 shows a displayed document on a computer screen in accordance with embodiments of the present invention. As preferred, the document is displayed in a form that closely resembles the appearance of a paper equivalent of the e-book and, in this case, a paper novel. The document reader window 101 may comprise a variety of portions including a title bar 101A listing the title of the document and a body 102. In the body 102 of the display window, various portions of a document may be displayed. FIG. 2 shows an example where a title 104, a chapter number 105, a chapter title 106, and the text of the chapter 107 are displayed. Similar to an actual book, margins 108, 109, 110, and 111 appear around the displayed text. As referred to herein, the displayed elements may be independently referenced. Here, for example object 103 “sleepy” has a drawing annotation placing a box around it as placed there by the user. The presence of icon 112 indicates that a text annotation is present in the line of text adjacent to the icon 112. While the icon 112 is represented as the letter “T” in a circle, it will be appreciated by those of skill in the art that other representations may be used to designate the presence of an annotation. For example, other letters may be used (for instance, the letter “A” for annotation) or other symbols may be used (for instance, a symbol of an open book) or any other representation that indicate that an annotation exists. Tapping on (or otherwise activating) the icon (or other designation) results in the display of a stored annotation.

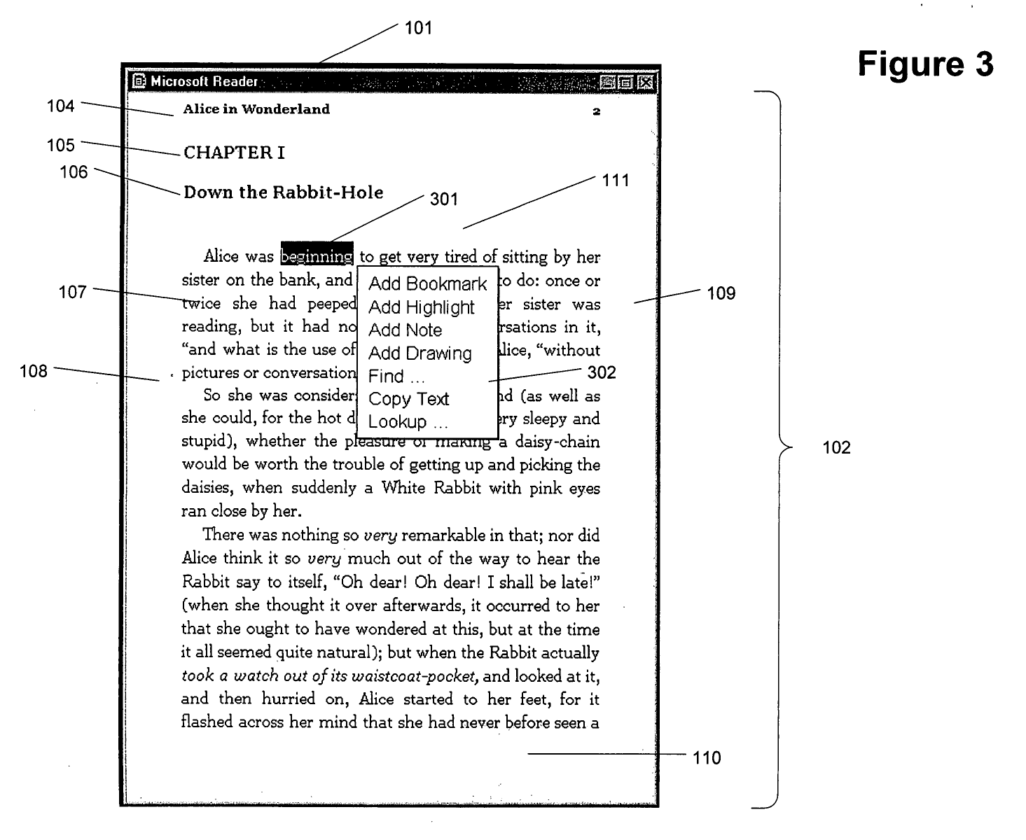

FIG. 3 shows a displayed window after an object has been selected. Here, for example, the object “beginning” 301 in the first line of text 107 was selected. The object may be selected through tapping the screen overlying the object with a stylus or a user's finger. Alternatively, a user may position a cursor over the object then select the object (by clicking a mouse button or by operating a designation source). As shown in FIG. 3, upon selection of the object, the object may be displayed as selected, meaning that the pixels that make up the object and surrounding pixels are inverted. Alternative embodiments include changing the color of the pixels surrounding the object or highlighting the object in some other way as is known in the art.

After an object has been selected, window 302 is displayed. Window 302 contains actions operable on the selected object. As represented in FIG. 3, the following options are displayed:

Add Bookmark

Add Highlight

Add Note

Add Drawing

Find . . .

Copy Text

Lookup . . .

Various aspects of the actions associated with these menu options are treated in greater detail in the following disclosures,

U.S. Ser. No. (BW 03797.80027), filed December, 1999, entitled “Bookmarking and Placemarking a Displayed Document in a Computer System,”

U.S. Ser. No. (BW 03797.84618), filed December, 1999, entitled “Method and Apparatus for Capturing and Rendering Text Annotations For Non-Modifiable Electronic Content,”

U.S. Ser. No. (BW 03797.78802), filed December, 1999, entitled “System and Method for Annotating an Electronic Document Independently of Its Content” and

U.S. Ser. No. (BW 03797.84617), filed December, 1999, entitled “Method and Apparatus For Capturing and Rendering Annotations For Non-Modifiable Electronic Content,” which are incorporated herein by reference for any essential disclosure.

Alternatively, window 302 may also have options including, for example, those that may affect the display of the content as well. For example, window 302 may include menu options that allow for switching from one book to another. An advantage of displaying more information to the user may include a net reduction in the number of navigation steps required to perform a process. For example, by providing a menu option to allow one to change which book is currently being displayed, a user may switch between books with a few navigational commands. However, the total options available to a user at any given time may be substantial. Due to the overcrowding of window 302, displaying all options decreases the intuitive nature of adding an annotation to a page.

As shown in FIG. 3, the number of options available to the user are limited. By providing a limited number of options, the menu quickly becomes tailored to the intention of the user. Also, the window 302 may be placed close to the selected object so as to minimize the distance needed to move a cursor or stylus to select one of the displayed menu items. By minimizing the actions displayed to the user, the desire to provide pure functionality to the user without cluttering the user's reading space is fulfilled.

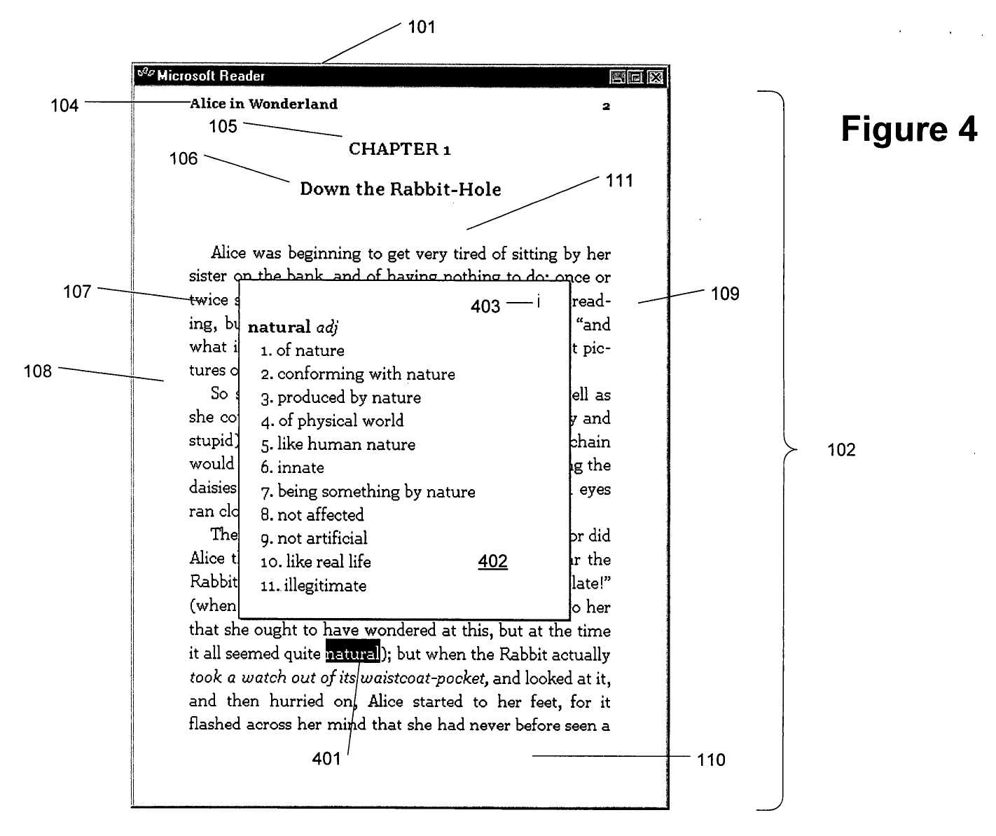

FIG. 4 shows a reference window 402 having been opened based on the selection of object 401 (here, the word “natural”) and the “Lookup . . .” option (from FIG. 3, window 302). Reference window 402 displays the results of looking up a definition for the word “natural.” In the example, of FIG. 4, only one reference document was consulted as only one document may have been installed in conjunction with the lookup functionality. As shown here, where only one reference document exists, the system may skip directly to the sole reference, rather than displaying to the user a choice of only one item. If multiple reference documents have been installed with the lookup functionality, then multiple choices relating to the documents installed may be available for the user for selection. In an alternative embodiment, a user may also be given the option of editing the form of the selected object (for lookup purposes). This editing may include a user adding characters which allow for variations of the word to be searched or looked up (e.g., a search for “natural*” would retrieve information on “natural,” “naturalize,” “naturalizing,” etc.).

FIG. 4 also shows the page number “i” as 403. In one embodiment, the page number is always displayed in order to provide the user with standard window appearance for reference window 402. In another embodiment, the page number 403 may be omitted where there is only enough information to fill one reference window 402 and included where there is more information than space available in a single window 402.

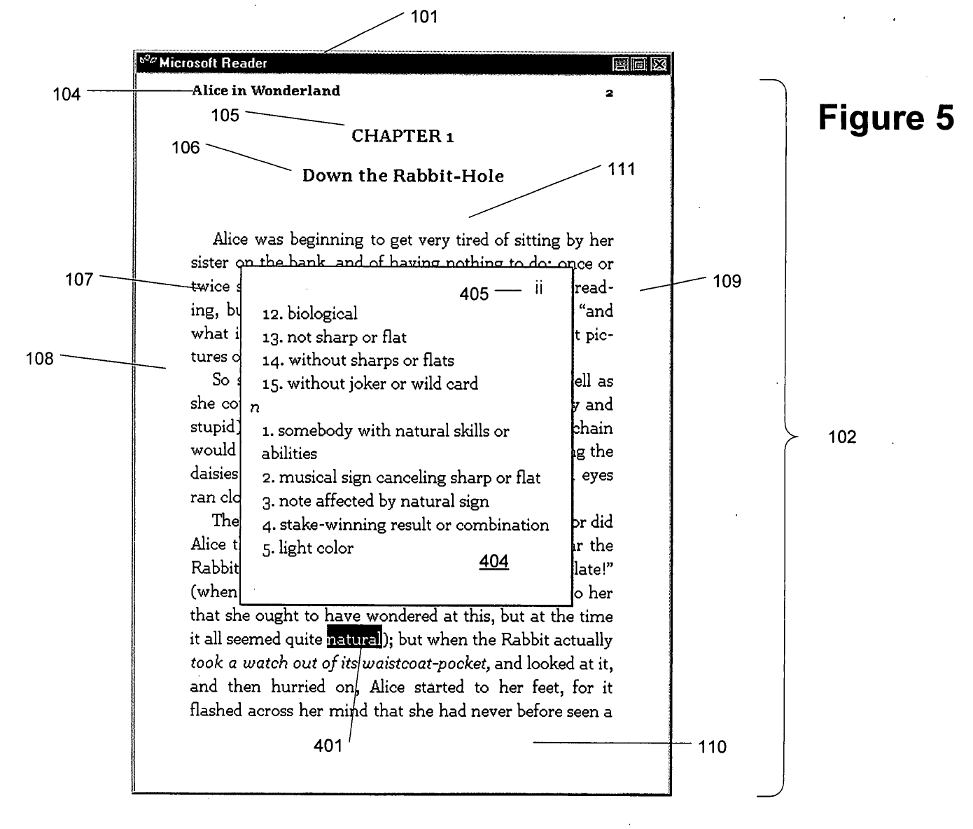

FIG. 5 shows an example of a second page of uncovered reference information relating to the object “natural.” The second page of reference information is shown as reference window 404 with page number 405. It will be appreciated that changing from reference window 402 to reference window 404 may or may not involve navigating to a new window. If multiple windows are employed, each reference window (402, 404) may overlie one another. Alternatively, they may be cascaded allowing a user to jump pages by selecting new windows. Further, there may only be a single reference window 402 with different content displayed therein with the content being altered only to display additional information regarding the selected object or on navigation to display new information for a newly selected object.

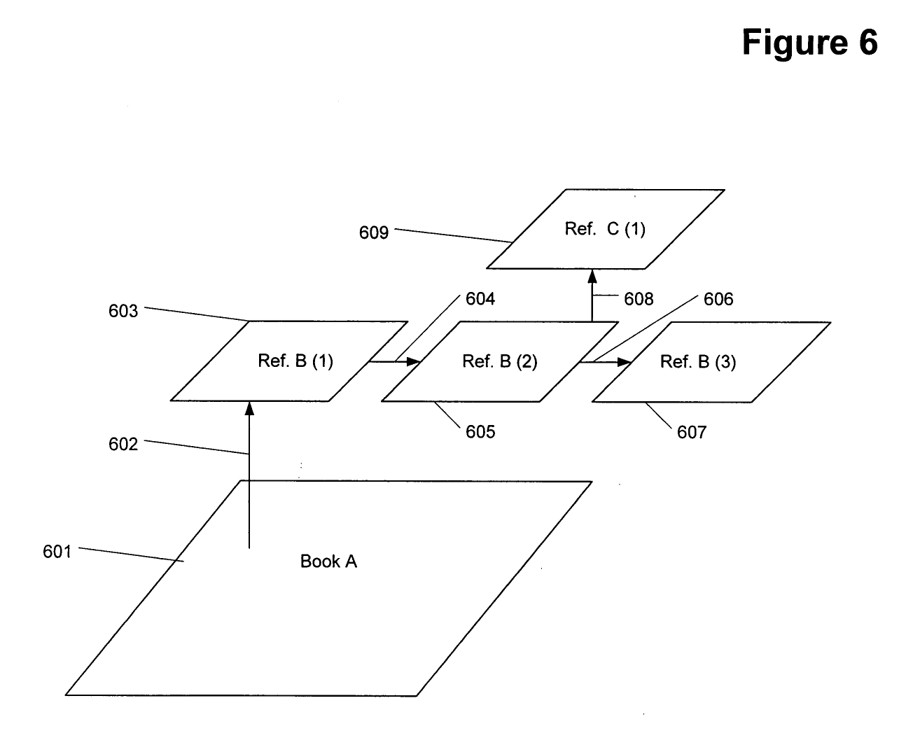

FIG. 6 shows a function diagram illustrating the relationships between intra-document and inter-document navigation of the reference window (402 and 404 above). Book A 601 is referred to as the original book (i.e., the book a user is currently reading and contains objects he wants to look up). Upon selection of an object and the lookup function, represented by arrow 602, reference window 603 displays content (1) of reference book B. Upon selecting an object displayed in window 603 and the lookup function (the selection step as shown as arrow 604), reference window 605 displays content (2) of reference book B. The content of a reference book displayed in window 603 may contain links referring to information elsewhere within reference book B. Clicking on such a link will automatically update window 603 to display the contents at the link destination. Alternatively the link destination may be displayed in a new reference window 605. Again, the user selects (shown by arrow 606) an object from reference book B and the lookup function. Reference window 607 is displayed with content (3) of reference book B. This is an example of intra-document navigation as the navigation has been between different content in reference book B. Alternatively, the user may navigate (shown by arrow 608) outside reference book B and into reference material C at content (1) 609. Reference material C may include non-textual material including graphic files, sound files, video clips, lists of additional links to yet other documents, and the like. Navigating from one reference material to another is referred to as inter-document navigation.

In the process of navigating to other documents that contain the result-set from their own lookups, users may be offered the option of carrying-out electronic commerce transactions, as some of the information returned from lookups may include, but not limited to, price lists for products in a catalog. One embodiment of this example has a user reading a book on gardening. Upon looking up more information for the words “underground sprinklers”, the user notices that one of the possible sources of information is a product catalog that has several models of underground sprinkler systems on sale. The user may navigate away from the current book she's reading and into that company's electronic catalog. At that point, she carries out the transaction and schedules an appointment for the system to be installed. Once that's done, she returns to the book on gardening she was reading with a simple tap/click on the Return link (always available).

This example is provided merely for illustrative purposes. The system explained in this disclosure is capable of providing a platform for a multitude of referenced and linked information navigation, including electronic transactions that result from impulse purchases on the part of the user reading the said linked/referenced information.

Again, by tapping outside any of windows 603, 605, 607, and 609, the user is able to quickly and smoothly navigate back to original book A with display 601.

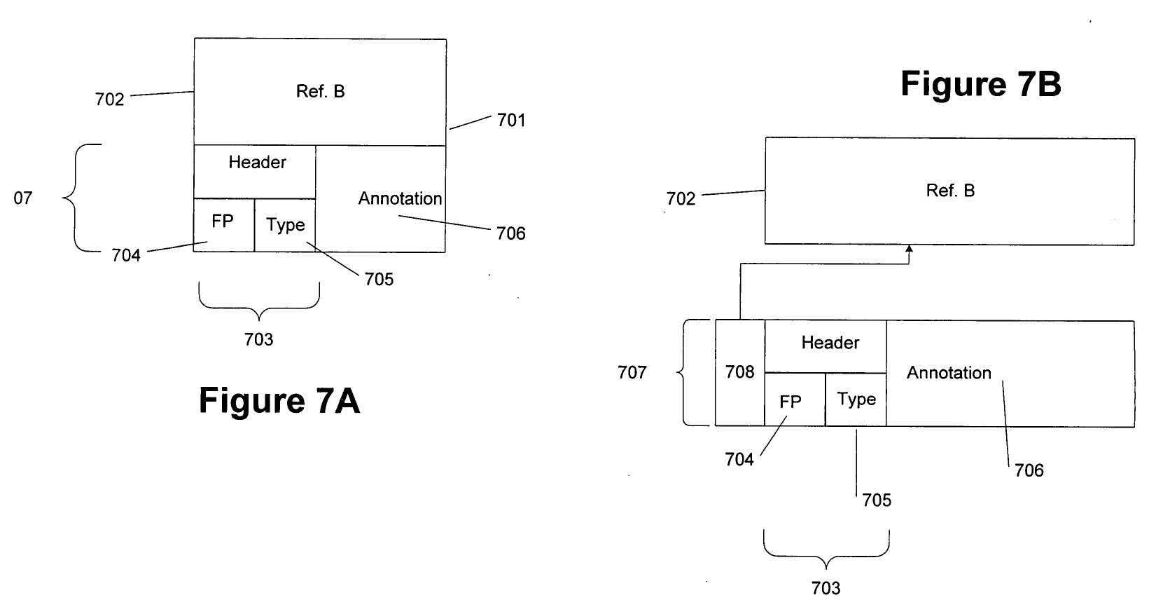

At any point, during the navigation of reference windows (603, 605, 607, and 609), a user may annotate a selected object (rather than use it as the basis for another lookup navigation). The annotation may be captured and stored as explained below in reference to FIGS. 7A and 7B.

FIGS. 7A and 7B show various storage techniques for storing annotations in accordance with embodiments of the present invention. FIG. 7A shows a reference B 701 as having been annotated. The file structure of FIG. 7A has modifiable (703-706) and non-modifiable (702) portions. Files of this type include Infotext file formats as are known in the art. Annotations 706 may be stored in combination with the non-modifiable content 702. An annotation 706 may be stored in a file with header 703 and body 706. The header 703 includes, for example, the file position 704 of the object with which the annotation 706 is associated. It may also include an indication of the type of annotation 706 in file portion 705. As discussed above, the annotation 706 may include a highlight, a bookmark, a drawing to be overlaid over the object, or a text annotation.

FIG. 7B shows the non-modifiable content of reference B702 as a separate file apart from the annotation file 707. The annotation file 707 of FIG. 7B has similar constituent elements to that of annotation file 707 of FIG. 7A. Annotation file 707 may include a file portion 708 that indicates to which non-modifiable document (here, 702) it is linked. Using the approach set forth in FIG. 7B, one file may store all annotations for a user with the non-modifiable content portions 702 being stored separately. This approach has the advantage of being able to quickly scan all annotations at one time rather than accessing all documents 701 (as including non-modifiable portions 707 of FIG. 7A) to obtain all annotations stored therein. Greater detail on how to create and store annotations is disclosed in U.S. Ser. No. (BW 03797.84617), filed December, 1999, entitled “Method and Apparatus For Capturing and Rendering Annotations For Non-Modifiable Electronic Content,” whose contents are incorporated by reference for any essential disclosure.

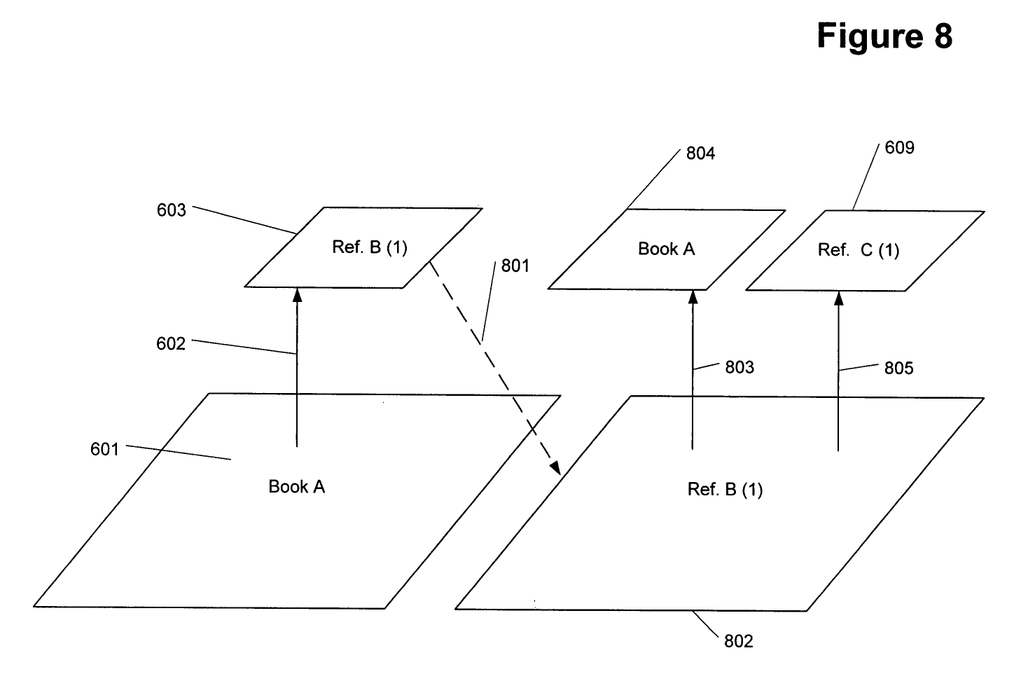

FIG. 8 shows the navigation of the underlying content (not just the referenced lookup). As discussed in relation to FIG. 6, a user is reading from original book A 601 and navigates to content (1) of reference book B 603 through selection of an object and lookup function as shown by arrow 602. Through user selection 801 (for example, a double tap of the displayed content (1) of reference book B), reference book B takes the place of original book A. The content (1) of reference book B is shown in original window (or display) 802. In this example, a user has signaled a preference that she wants to read in full the entry for content (1) of reference book B. For example, this may indicate that the user wants to read an entire entry in an electronic encyclopedia. From reading content (1) of reference book B, a user selects an object for lookup. In this example, the options for reference books include reference C 609 as well as book A 804. So, through selection of objects and lookup options, a user navigates through arrow 803 to reference window 804 displaying content from book A or navigates through arrow 805 to reference window 609 displaying content (1) from book C. An example of a circular navigation immediately described is when a user is reading a book (book A 601) on marine life and looks up the object “whales” that navigates a user to a relevant section on whales in an encyclopedia (book B 603). The user decides he would rather read more in the encyclopedia and switches the encyclopedia from reference window 603 to reader window 802. While reading on whales, the user encounters the object “barnacles” and looks up this word in the stored reference on marine life (book A) in reference window 804.

Another way for the user to switch the underlying book/document with the one containing the results of the lookup performed is via a drop-down menu at the top of the Lookup Window. The menu would provide for navigation commands easily accessible to the user, which would also maintain a history of jumps “taken” by the user via the Lookup Window, such that the user would be able to quickly return to any of the recently accessed publications.

C. Description of Book Storage Structure

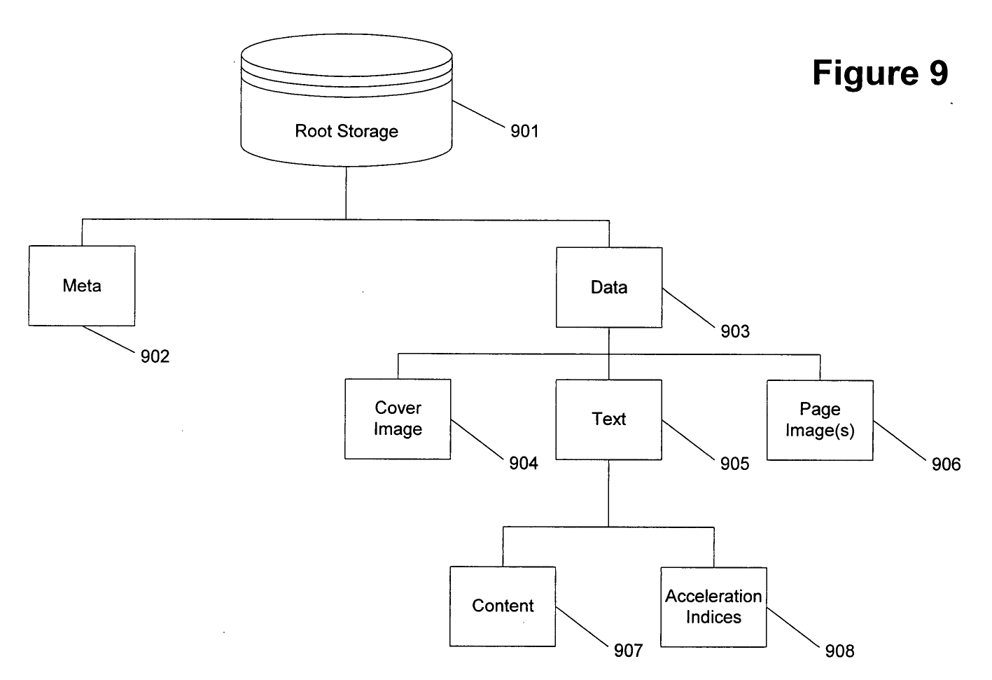

FIG. 9 shows an example of a storage structure for a book. Root storage 901 provides the general storage of a book for the disclosed system. The storage 901 may take the form of a fixed drive or solid state memory in a general computing device, a handheld computer, or a dedicated electronic book reading device.

A book may generally considered to include at least two portions: a metadata portion 902 (also referred to herein as “meta” for simplicity) and a data portion 903. Meta portion 902 contains tag information that generally describes the content or function of a book. Meta portion may include information such as “creator,” “title,” “copyright information,” “thumbnail,” “document reference,” and other related tags. Meta portion 902 would also contain the required tags that identify an electronic publication as a reference title. These tags can contain a defined structure with many relevant “keywords” that will later facilitate the reader software to categorize the reference title and identify the manner in which the reference title contents should be handled to provide maximum benefit to the user. (E.g. <meta name=“dictionary” content=“stemmable”/>). Data 903 is the underlying information described by meta portion 902. Data 903 may comprise at least three sub-portions including cover image 904 (to be displayed when opening the book), the text 905 of the book, and a page image or images 906 including images to be displayed as, for example, textual illustrations found in a print book.

Finally, text portion 905 may be subdivided into content 907 and acceleration indices 908 for accelerating the speed by which the system may locate and display a selected portion of the book 901.

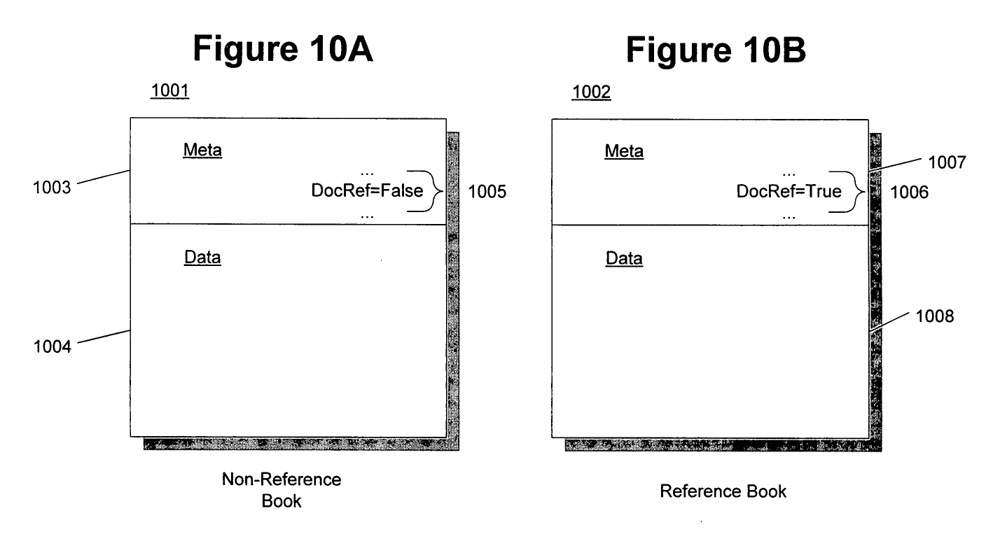

FIGS. 10A and 10B disclose a document format for books. For non-reference book 1001 as shown in FIG. 10A, the file structure is separated into two portions: a meta portion 1003 and a data portion 1004. Of relevance here, meta portion 1003 includes an entry DocRef=False 1005. This meta entry indicates that the document 1001 is not a reference book or document. As an alternative, book 1001 may not contain the DocRef entry in its meta portion. This absence of the DocRef entry may also be interpreted to signify that the document 1001 is not a reference book or document. FIG. 10B shows a structure similar to that of FIG. 10A. Here, reference book 1002 includes meta portion 1007 and data portion 1008. However, in meta portion 1007, book 1002 includes a reference 1006 as DocRef=True. This meta entry indicates that the document 1002 is a reference book. This means that, when added to a system, the book 1002 should be referenced as both a normal book (as readers sometimes want to browse a reference book) as well as a reference book. This inclusion of a reference book allows for its title to be displayed to a user during a lookup action. The example provided on FIG. 10B is merely illustrative and not the full scope of the tags that can be used to differentiate reference documents from regular, read-only documents. Given that this structure is extensible, it will be appreciated by any one skilled in the art that various tags (e.g. type=“encyclpedia”, multimedia=“yes”, onlinefunctions=“no”, and the like) may be used to more granularly identify and categorize reference publications.

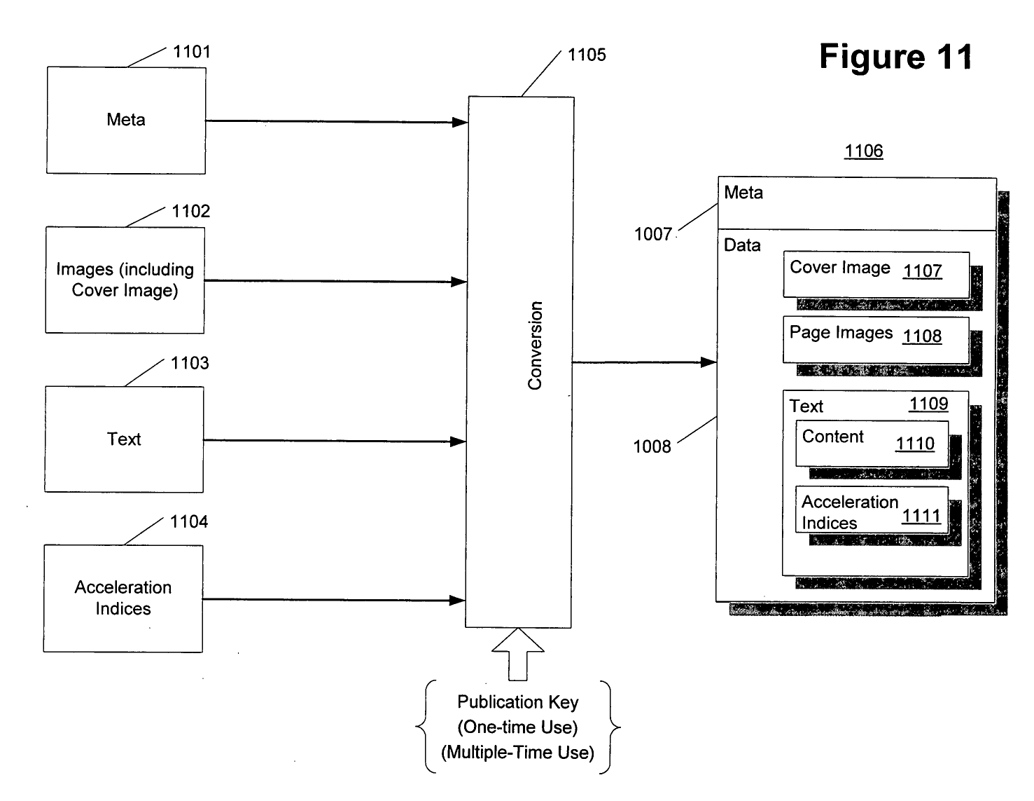

FIG. 11 shows an example of how a publisher may create books for reading by reading software. A publisher generates a variety of files including meta file 1101, image file (including cover images) 1102, text file 1103, and Acceleration Indices 1104. These files are passed through a conversion module 1105 where the file portions 1101-1104 are combined and stored as book 1106. Book 1106 includes meta portion 1007 and data 1008. Data portion 1008 includes cover image 1107, page images 1108, and text portion 1109 (as including content portion 1110 and acceleration indices 1111). Through specification of meta information, a file format, a file extension, or another trigger as understandable to one of ordinary skill in the art, the function of conversion module 1105 may be modified so as to output book 1106 as a reference book as opposed to a book 1106 on its own.

Various business methods exist for generating income based on the creation of books. First, the publisher may be free to allow anyone to create books and the reader be purchased, the reader being the device used to read the generated books. Second, the reader may be free and the publishing platform may be purchased at a price. This situation provides the advantages of generating revenue based on the publishing entities. However, this model quickly leads to its own demise as the market may quickly become saturated with purchased and underutilized publishing modules. Finally, the reader and publisher may be distributed without cost with there being a fee per each publication of a document. This publication step may also be referred to as a converting step. An advantage of this system is that it maintains a continuous cash flow to the creator of the publishing module.

Further, the entries within the reference book may be specially formatted to allow for faster lookups.

D. Description of Reference Manager

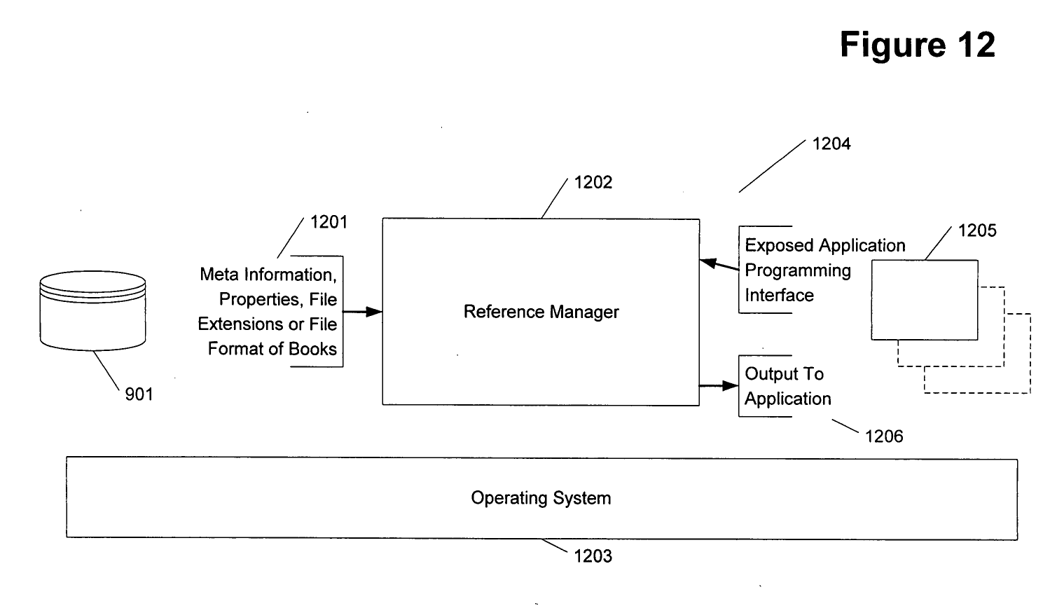

FIG. 12 shows reference manager 1202 seated between book storage 901 and applications 1205. All sit on operating system 1203. Reference manager 1202 controls the contents of the reference windows as well as what functions are available to the rest of the computer system. Various information may be scanned by reference manager 1202. The information may include meta information, properties of stored files, file extensions, or file formats, for example. This information allows reference manager to determine the amount and type of reference information available to a user. For example, a scan of the reference materials may result in finding one dictionary, one foreign language translator, one map of the world, three catalogs, two travel guides, etc. Reference manager 1202 stores this information and uses this information to determine what reference book titles should be projected to the user for eventual selection. For example, if a user selects an object comprising an equation and the reference manager 1202 knows that there are no reference books that relate to equations (handbooks, engineering books, math books, etc.) then reference manager 1202 may not necessarily provide any reference books to the user for selection for lookup. However, the reference manager 1202 may allow a user to recast the object being looked up.

As shown in FIG. 12, section 1204 is the exposed application programming interface (API) for the reference manager. Here, this interface is exposed to other applications 1205 for their use. For example, one may download an application 1205 that helps identify groceries and create a shopping list. With the application 1205, a user may rummage through their refrigerator and pantry making notes of what they need on their handheld device running application 1205. Instead of burdening application with all possible groceries available at the user's local market, one of the stored reference books in 901 may be a listing of the local grocers items for that season with associated prices. Another reference book stored in storage 901 may be a grocer that sells goods over the Internet. When running the application 1205, the user's selections may be passed through reference manager 1202 to determine whether the local grocer has any of the desired products in stock and, if not, then to display alternatives. For example, a user may desire a list of apples available. Application 1205 would pass a command such as referencemgr.list(value=“apples”) for a command sent to reference manager 1202 to list all items that are in some way related to apples. The result would be passed back to application 1205 via the output of reference manager 1206. This interface may be generalized as a call to reference_manager.command (value=“information”).

E. Use of Reference Manager

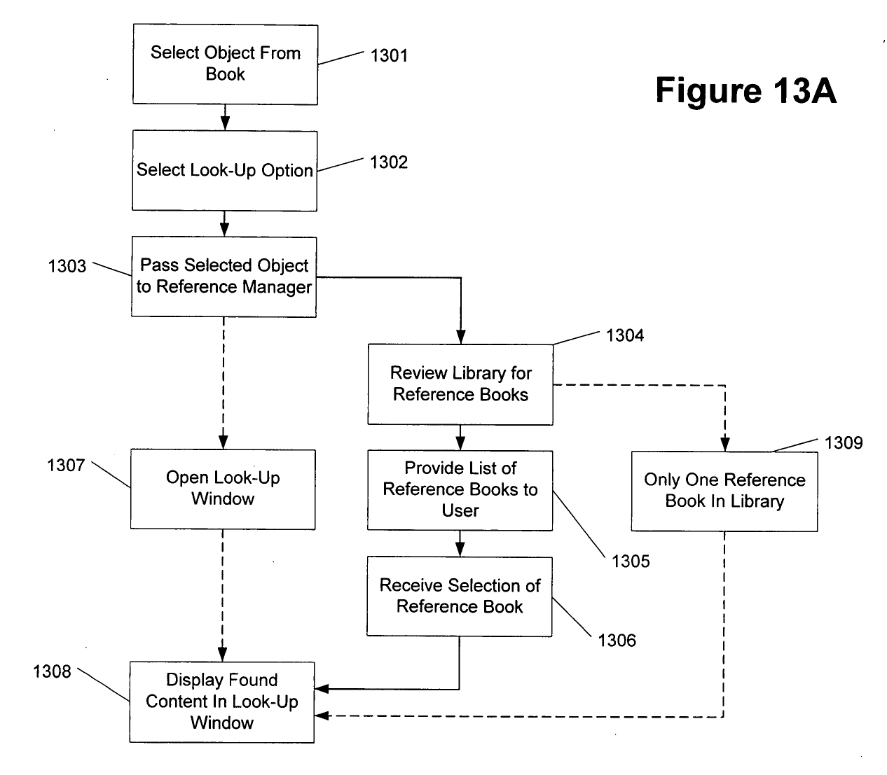

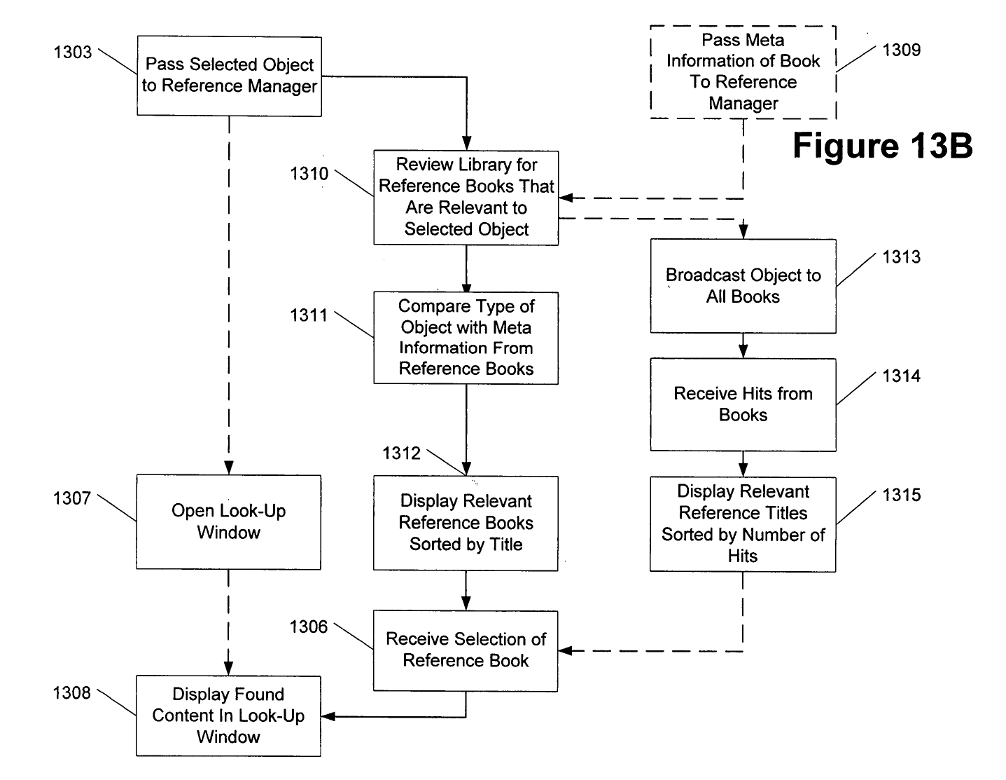

FIGS. 13A and 13B show the operation of reference manager 1202 in response to a user's command to look up objects. As shown in FIG. 13A, a user selects an object from a book in step 1301. Next, the user selects the look-up option 1302. The system passes the selected object to the reference manager in step 1303. Reference manager 1202 reviews the library of stored books for reference books in step 1304 and provides a list of reference books to the user in step 1305. In the meantime, the system opens a reference or look-up widow in step 1307. The arrows to and from step 1307 are dotted in that when and where step 1307 occurs is not important as it may occur in parallel with steps 1304-1306 or in series with these steps. The user selects one of the books in step 1306 and the end results are displayed in the look-up window in step 1308. If there is only one reference book in the library, then steps 1305 and 1306 are unnecessary and may be replaced by step 1309 that takes the sole reference as the default selection.

FIG. 13B shows alternative steps for determining which reference books should be displayed to the user. Starting with step 1303 from FIG. 13B, the system passes the selected object to the reference manager. The reference manager 1310 reviews the library for reference titles relevant to the searched object. To assist in determining what types of information are relevant to the selected object, various information may be passed along with the object. For example, the contextual use of the selected object may be passed with the selected object (for instance, the entire sentence in which the selected object appeared may be passed so that the reference manager may more appropriately determine the meaning of the selected term in context). Alternatively, meta information from the original book may be passed (step 1309) in conjunction with the selected object so to provide the reference manager with information relating to the general context of the selected object. Next, the reference manager 1311 compares the type of object (as determined from the information passed with the object or through step 1309) with the meta information from the reference books (step 1311). The relevant reference books are sorted and displayed by title (step 1312). The user selects which book he wants to use as a reference book (step 1306) and the result of the lookup in the selected reference book is displayed in the look-up window 1308.

Instead of steps 1311 and 1312, the reference manager may determine the number of hits in each reference book by broadcasting the selected object to all reference books and receive the number of hits from each in step 1314. The reference manager may then display the found reference titles as sorted by the number of hits (step 1315). Finally, the user selects on the displayed reference titles in step 1306.

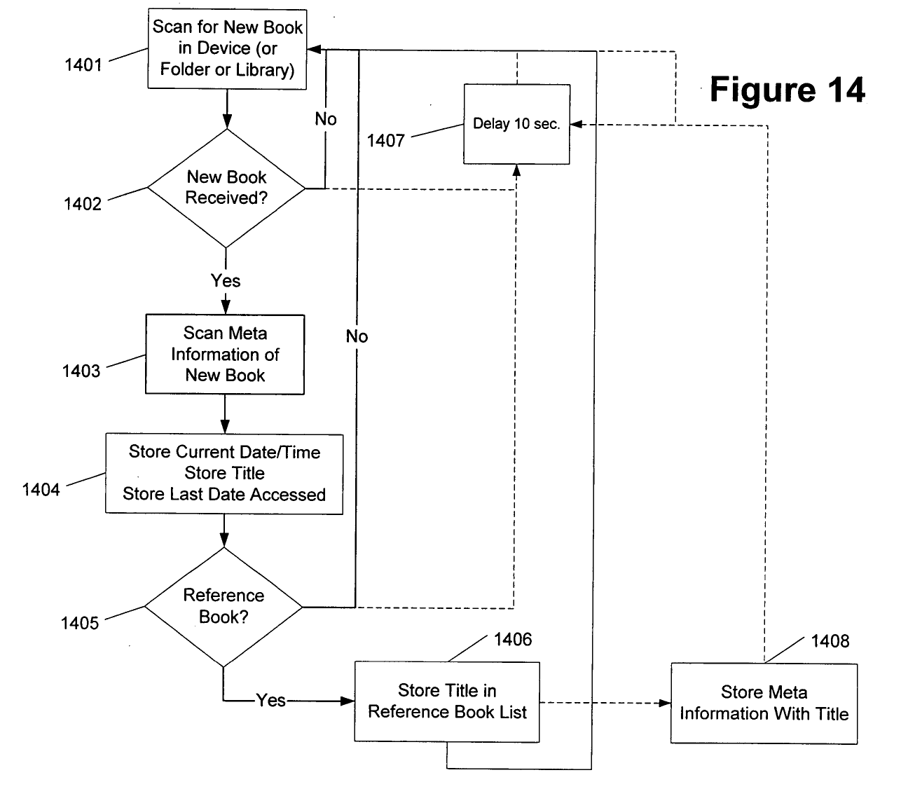

FIG. 14 relates to the use of the reference manager to scan new books for reference information and to store them as reference titles. In step 1401, the system scans for newly deposited books. With respect for a desktop or laptop implementation of the invention, the scan may include a single folder (for example, entitled “Library”). On a handheld computer or dedicated device, the amount of area to be scanned is generally limited (because of lessor storage size than that present in a desktop system) so the reference manager may scan the entire storage structure of the handheld or dedicated device for new books. This scanning may occur every 10 seconds. This value is given by way of example and is not intended to be limiting.

At the end of the scan, it is determined whether any new books have been found (step 1402). If no new book has been received, the system steps back to step 1401. The system may delay 10 seconds (step 1407) if desired. If a new book was found, the system scans the meta information of the book (step 1403) and stores the meta information (for example, the current date and time, the title of the book and the last date accessed) for future reference. The system then queries whether the new book is a reference book (step 1405). If no, the system steps to step 1401 or to step 1407. If yes, the system stores the title in the reference book list in step 1406 and returns to one of step 1401 or 1407. Finally, the system may also store (1408) the reference book meta information apart from the standard meta storage information 1404 for quicker access for later retrieval.

F. Summary

The reference window and reference manager have been described. While the reference window has been described and shown with a windowing shape surrounding displayed text, one of ordinary skill in the art will appreciate various alternative techniques for representing information without overlying windows including, but not limited to, graying out of lower level content and change in colors between layers.

In the foregoing specification, the present invention has been described with reference to specific exemplary embodiments thereof. Although the invention has been described in terms of various embodiments, those skilled in the art will recognize that various modifications, embodiments or variations of the invention can be practiced within the spirit and scope of the invention as set forth in the appended claims. All are considered within the sphere, spirit, and scope of the invention. The specification and drawings are, therefore, to be regarded in an illustrative rather than restrictive sense. Accordingly, it is not intended that the invention be limited except as may be necessary in view of the appended claims.

1. A computer implemented method for publishing a reference book for a computer apparatus having a touch sensitive display, the reference book including a read-only portion being displayable on said display and a writeable portion for receiving annotations configure to facilitate searching of the read-only portion, the method comprising the steps of:
receiving meta information relating to content of the reference book;
receiving computer readable content being storable in the read-only portion of the reference book; and
converting the meta information and the computer readable content into a computer readable meta portion and the read-only portion to form the reference book.

2. The method according to claim 1, further comprising a step of receiving a front cover image being associated with a selection of the reference book on the computer apparatus; and wherein said converting step further includes a step of converting the image to the read-only portion.

3. The method according to claim 1, in which the step of receiving the computer readable content includes a step of receiving a link destination configured for intranavigational movement within the computer readable content, said link destination being storable in said read-only portion.

4. The method according to claim 1, in which the step of receiving the computer readable content includes a step of receiving a link destination configured to provide internavigational movement to another electronic reference book, said link destination being storable in said read-only portion.

5. The method according to claim 1, in which the step of receiving the computer readable content includes a step of receiving a link destination configured to provide internavigational movement to an electronic reference source different from the reference book, said link destination being storable in said read-only portion.

6. The method according to claim 1, in which the step of receiving the computer readable content includes a step of receiving a link destination configured for internavigation movement to a remote electronic reference location, said link destination being storable in said read-only portion.

7. The method according to claim 1, wherein said meta information includes a data delimiter configured to categorize the content of the reference book and identify processing of said book within said computer apparatus.

8. The method according to claim 1, wherein said read-only portion includes linked information configured for navigation enabling electronic commerce transactions related to the computer readable contents of the reference book.

9. A computer readable medium having an electronic reference book thereon, said electronic book being executable for a computer apparatus having a display, comprising:
a read-only portion being displayable on said display;
a writeable portion for receiving annotations configure to facilitate searching of the read-only portion; and
meta information relating to a content of the electronic reference book in said read-only portion; and said content being stored in the read-only portion.

10. The computer readable medium according to claim 9, further comprising a front cover image being associated with a selection of the reference book on the computer apparatus; and wherein front cover image is stored in the read-only portion.

11. The computer readable medium according to claim 9, wherein the content includes a link destination configured for intranavigational movement within the computer readable content, said link destination being storable in said read-only portion.

12. The computer readable medium according to claim 9, wherein the content includes a link destination configured to provide internavigational movement to another electronic reference book, said link destination being storable in said read-only portion.

13. The computer readable medium according to claim 9, wherein the content includes a link destination configured to provide internavigational movement to an electronic reference source different from the reference book, said link destination being storable in said read-only portion.

14. The computer readable medium according to claim 9, in which the content includes a step of receiving a link destination configured for internavigation movement to a remote electronic reference location, said link destination being storable in said read-only portion.

15. The computer readable medium according to claim 9, wherein the read-only portion includes linked information configured for navigation enabling electronic commerce transactions related to the computer readable contents of the reference book.

16. The computer readable medium according to claim 9, wherein said display is touch sensitive and in which said content in said read-only portion is tap responsive.
